(19) United States
(12) Patent Application Publication
(10) Pub. No.: US 2004/0258505 A1
(43) Pub. Date: Dec. 23, 2004

(54) Processing equipment modular font-end

(76) Inventor: Kung Chris Wu, Sunnyvale, CA (US)

Correspondence Address: Donald E. Schreiber, A Professional Corporation, Post Office Box 2926, King Beach, CA, 96143-2926, US

(21) Appl. No.: 10/860,825

(22) Filed: Jun. 4, 2004

Related U.S. Application Data
(60) Provisional application No. 60/475,800, filed on Jun. 4, 2003.

(51) Int. Cl. B65G 1/00

(52) U.S. Cl. 414/217.1

(57) ABSTRACT

A front-end module exchanges semiconductor wafers between a pod and a semiconductor processing tool to which the front-end module is secured. The front-end module includes a robot arm for exchanging semiconductor wafers, either individually or in a wafer carrier, between the pod and the semiconductor processing tool. The front-end module also includes at least one load-port-interface frame having a platform which receives and supports a pod opener. The load-port-interface frame is adjustable with respect to the robot arm for aligning thereto a pod opener received on the platform thereof. By adjusting the platform, a pod opener supported on the platform of the load-port-interface frame may be accurately located with respect to the robot arm.

### CLAIM OF PROVISIONAL APPLICATION RIGHTS

This application claims the benefit of United States Provisional Patent Application No. 60/475,800 filed on Jun. 4, 2003.

### BACKGROUND OF THE INVENTION

1. Field of the Invention

The present invention relates generally to semiconductor processing equipment such as that used for semiconductor fabrication and, more particularly, to front-end silicon wafer substrate handling equipment.

2. Description of the Prior Art

Handling of silicon wafer substrates is a indispensable operation in integrated circuit (“IC”) manufacturing. Any physical damage to semiconductor wafers during handling will, of course, decrease the chip yield, which is a prime consideration in the profitability of semiconductor manufacturing. Contamination of semiconductor wafers by particulate or other contaminants also decreases chip yield. For several decades the semiconductor manufacturing industry has addressed its need to reduce damage and contamination during semiconductor processing by replacing human operators, as much as practicable, with robot semiconductor wafer handling equipment.

The desire to shield semiconductor wafers from contaminants has led the semiconductor industry to develop and use Standard Mechanical InterFace (“SMIF”) pods. SMIF pods allow 200 mm diameter, disk-shaped, semiconductor wafers to be transported in a clean, sealed environment shielding them from ambient air.

Once the SMIF pods reach their destination, they must be opened and a wafer carrier enclosed within the SMIF pod must be positioned, usually inside a semiconductor processing tool, for the desired processing operation. If the unloading and positioning operation is performed manually, the semiconductor wafers are subjected to the usual risk of damage from mishandling as well as increased exposure to contamination.

To reduce both risk of damage and exposure to contamination, pod loader interfaces are used extensively in semiconductor fabs to:

1. automatically unload from the SMIF pod the wafer carrier that holds the wafers and position the wafer carrier in a semiconductor processing tool for the processing operation, and then

2. reload into the SMIF pod the wafer carrier that holds the semiconductor wafers from the semiconductor processing tool upon completing the processing operation.

In general, such pod loader interfaces include an arm for transporting the wafer carrier together with the semiconductor wafers between a clean mini-environment established within the pod loader interface and the semiconductor processing tool which performs the processing operation. U.S. Pat. Nos. 5,984,610 and 6,086,323, which are hereby incorporated by reference, disclose and claim a pod loader interface for handling SMIF pods that performs the wafer handling operations described above.

After SMIF pods and pod loader interfaces had been in use for several years, semiconductor equipment manufacturing companies adopted a new standard for sealed pods to be used for transporting 300 mm diameter, disk-shaped, semiconductor wafers between semiconductor processing tools. This new standard pod, identified by the name Front Opening Unified Pod (“FOUP”), differs mechanically from the earlier SMIF pod for 200 mm diameter semiconductor wafers in various ways. For example, exposing 200 mm diameter semiconductor wafers that are enclosed within the prior SMIF pod requires unlatching and removing from a base of the SMIF pod a one-piece removable cover that provides the top and sides of the SMIF pod. Alternatively, gaining access to 300 mm diameter semiconductor wafers enclosed within the newer FOUP requires unlatching and removing a door from one side of the pod.

Furthermore, while the prior SMIF pod has only one size, the more recently adopted standard actually envisions four different sizes of FOUPs. First, the standard envisions FOUPs that are capable of carrying, in uniformly-spaced slots located within the FOUP, either 13 or 25 semiconductor wafers. These two different classes of FOUPs are respectively identified by the phrases shorter FOUP and taller FOUP. Second, the standard also envisions FOUPs identified as unified or non-unified. A non-unified FOUP encloses a separately removable wafer carrier that, depending upon the carrying capacity of the FOUP, holds either 13 or 25 semiconductor wafers in its uniformly-spaced slots. Conversely, a unified FOUP omits the separately removable wafer carrier. Thus, in general, a unified FOUP allows removing only a single semiconductor wafer at a time from the FOUP's uniformly-spaced slots, or inserting only a single semiconductor wafer at a time into one of the FOUP's slots. Conversely, a non-unified FOUP allows simultaneously removing from the FOUP, en masse, as many as 13 or 25 semiconductor wafers that are held within the wafer carrier, or simultaneously inserting into the FOUP, en masse, as many as 13 or 25 semiconductor wafers that are held within the wafer carrier. Because the non-unified FOUP must enclose the separate, removable wafer carrier, the non-unified FOUP has a larger exterior than the smaller unified FOUP capable of carrying an identical number of semiconductor wafers. Correspondingly, the more recently adopted standard envisions four different sizes for the door on the side of the FOUP that must be removed to gain access to 300 mm diameter semiconductor wafers enclosed within the FOUP. U.S. Pat. No. 6,013,920, which is hereby incorporated by reference, discloses and claims a pod loader interface for handling FOUPs that performs the wafer handling operations described above.

For various reasons, semiconductor manufacturers have not converted to processing 300 mm diameter silicon wafers quickly. First, the cost of a silicon wafer substrate for equal surface areas, e.g. per mm², is greater for 300 mm diameter silicon wafers than for 200 mm diameter silicon wafers. Also for many IC designs which individually occupy only a small surface area on a silicon wafer, or for IC designs which are not manufactured in large quantities, use of 300 mm diameters silicon wafers proves to be economically unattractive. Thus far, in general, semiconductor processing equipment manufacturers have responded to the existence of this pluralistic semiconductor wafer size environment, i.e. some semiconductor fabs using 200 mm diameter semiconductor wafers while other semiconductor fabs use 300 mm diameter semiconductor wafers, by offering various types of semiconductor processing tools both in one model for processing the smaller diameter semiconductor wafers and in another model for processing the larger diameter semiconductor wafers.

Recently the semiconductor processing industry has realized that complete conversion from processing 200 mm diameter semiconductor wafers to processing only 300 mm diameter semiconductor wafers may be prolonged, and for some semiconductor fabs may never occur. Furthermore, the semiconductor processing industry has realized that in a pluralistic semiconductor wafer diameter environment various economies would accrue if a single semiconductor processing tool were adaptable for sequentially processing a batch first of one diameter semiconductor wafers, e.g. 200 mm diameter semiconductor wafers, and then subsequently processing a batch of semiconductor wafers having a different diameter, e.g. 300 mm diameter semiconductor wafers. While internally such multi-size semiconductor processing tools necessarily require various adaptations to permit processing semiconductor wafers having differing diameters, a significant problem also arises from the totally different configurations and operating requirements for the SMIF pod and the four different types of FOUPs. However, due to down-time that will be needed for converting a semiconductor processing tool from processing semiconductor wafers having one diameter, e.g. 200 mm, to processing semiconductor wafers having a different diameter, e.g. 300 mm, a significant economic impediment exists to adoption of multi-size semiconductor processing tools.

One factor contributing to down-time needed for converting a semiconductor processing tool for processing a different size of semiconductor wafer is the need to change between a SMIF and a FOUP pod loader interface. Present SMIF and FOUP pod loader interfaces are stand-alone, interchangeable units which rest directly on the floor, and are bolted alongside a semiconductor processing tool. Casters included in these different types of pod loader interfaces permit them to be rolled up to a semiconductor processing tool and to be rolled away therefrom usually when a pod loader interface requires servicing. However changing one SMIF pod loader interface for another or changing one FOUP pod loader interface for another involves far more than simply unbolting the first pod loader interface from the semiconductor processing tool, rolling it away, rolling another pod loader interface alongside the semiconductor processing tool, and bolting the second pod loader interface to the semiconductor processing tool. Rather, securing the replacement pod loader interface to the semiconductor processing tool requires an onerous and time consuming precise alignment of the second pod loader interface to the semiconductor processing tool. U.S. Pat. Nos. 5,885,045 and 6,193,459 disclose one technique for reducing the difficulty of precisely aligning a replacement pod loader interface to a semiconductor processing tool.

### BRIEF SUMMARY OF THE INVENTION

An object of the present invention is to provide a simpler way for precisely aligning a replacement pod loader interface to a semiconductor processing tool.

Another object of the present invention is to provide a simpler way for precisely aligning to a semiconductor processing tool different types of pod loader interfaces which are respectively adapted for operating with SMIF pods or FOUPs.

Yet another object of the present invention is to provide a more cost effective front-end module which are respectively adapted for operating with SMIF or FOUP pods.

Briefly, the present invention is a front-end module for exchanging semiconductor wafers between a pod and a semiconductor processing tool to which the front-end module is secured. The front-end module includes a robot arm for exchanging semiconductor wafers, either individually or in a wafer carrier, between the pod and the semiconductor processing tool. The front-end module also includes at least one load-port-interface frame having a platform which receives and supports a pod opener. The load-port-interface frame is adjustable with respect to the robot arm for aligning thereto a pod opener received on the platform thereof. By adjusting the platform, a pod opener supported on the platform of the load-port-interface frame may be accurately located with respect to the robot arm.

These and other features, objects and advantages will be understood or apparent to those of ordinary skill in the art from the following detailed description of the preferred embodiment as illustrated in the various drawing figures.

### BRIEF DESCRIPTION OF THE DRAWINGS

FIG. 1 is a partially cut-away, perspective view illustrating a front-end module including a robot arm, an operator's console, and two load-port-interface frames on which respectively rest a half-height pod opener;

FIG. 2 is a perspective view illustrating one of the loadport-interface frames depicted in FIG. 1, each of which is adapted to receive a half-height pod opener;

FIG. 3 is a perspective view illustrating in greater detail one of the load-port-interface frames depicted in FIG. 1 that also appears in FIG. 2 illustrating multiple degree of freedom adjustment of an opener platform of the load-port-interface frame;

FIG. 3A is an plan view taken along the line 3A-3A in FIG. 3 which illustrates an adjustment of the load-port-interface frame in a one particular degree of freedom;

FIG. 4 is a perspective view illustrating a half-height SMIF pod opener that is adapted to be received onto of the load-port-interface frame depicted in FIG. 2; and

FIG. 5 is a perspective view illustrating a half-height FOUP opener that is adapted to be received onto of the load-port-interface frame depicted in FIG. 2.

### DETAILED DESCRIPTION

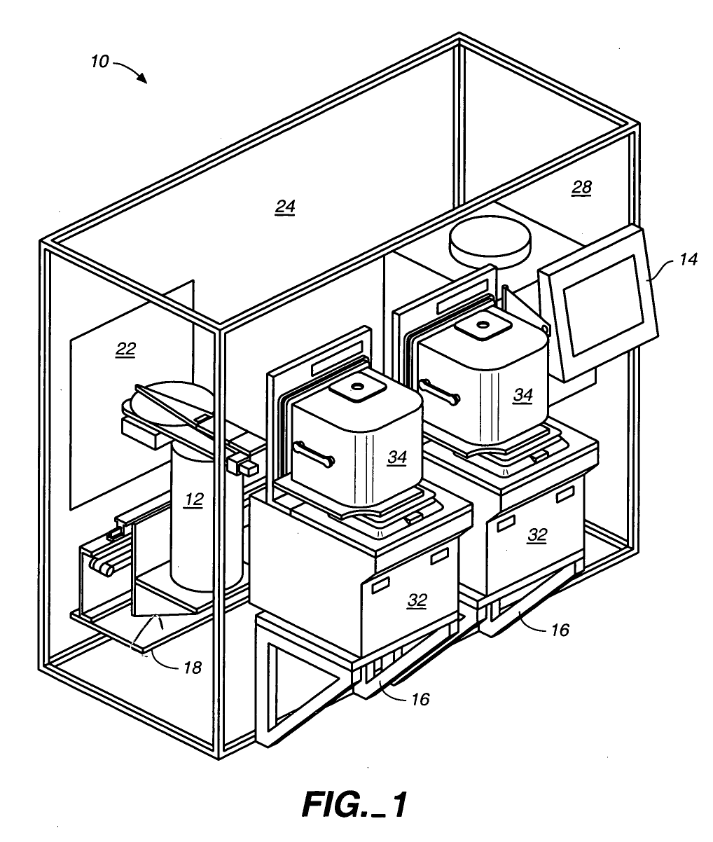

FIG. 1 depicts a front-end module, referred to by the general reference character 10, that is adapted to be secured alongside a semiconductor processing tool, not illustrated in FIG. 1. The front-end module 10 includes a robot arm 12, an operator's console 14, and two (2) load-port-interface frames 16. The robot arm 12, which moves back and forth laterally along a rail 18 within the front-end module 10, is preferably a SCARA arm of a type disclosed in U.S. Pat. No. 6,494,666 that is hereby incorporated by reference. The front-end module 10 includes an opening 22 that pierces a rear wall 24 of the front-end module 10 facing the processing tool. The robot arm 12 exchanges either an individual semiconductor wafer or a wafer carrier with the semiconductor processing tool via the opening 22.

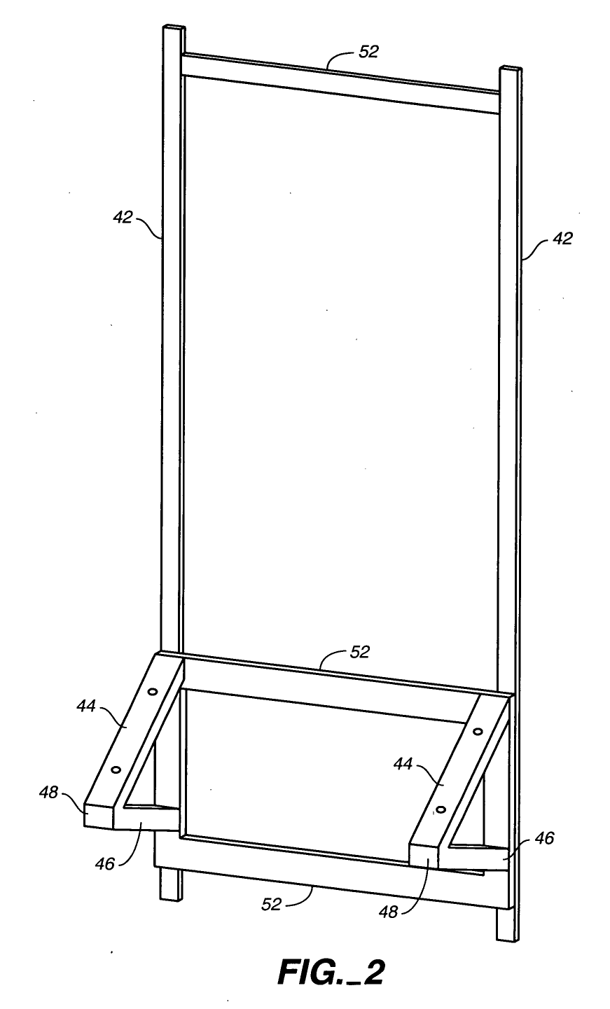

In the illustration of FIG. 1, each load-port-interface frame 16 is secured to a front wall 28 of the front-end module 10. Each load-port-interface frame 16 is adapted for receiving and supporting a half-height FOUP opener 32 that in the illustration of FIG. 1 supports a FOUP 34. The load-port-interface frame 16, as better illustrated in FIG. 2, includes a pair of spaced-apart vertically oriented rails 42 that are secured to the front wall 28 of the front-end module 10. A horizontally oriented beam 44 respectively projects outward from each of the rails 42 away from the front wall 28. A brace 46 slopes downward diagonally from an end 48 of the beam 44 furthest from the rail 42 toward a lower end of the rail 42 to support the beam 44 rigidly with respect to the rail 42. Three horizontally oriented braces 52 are fixed between the rails 42 separated along the length of the rails 42.

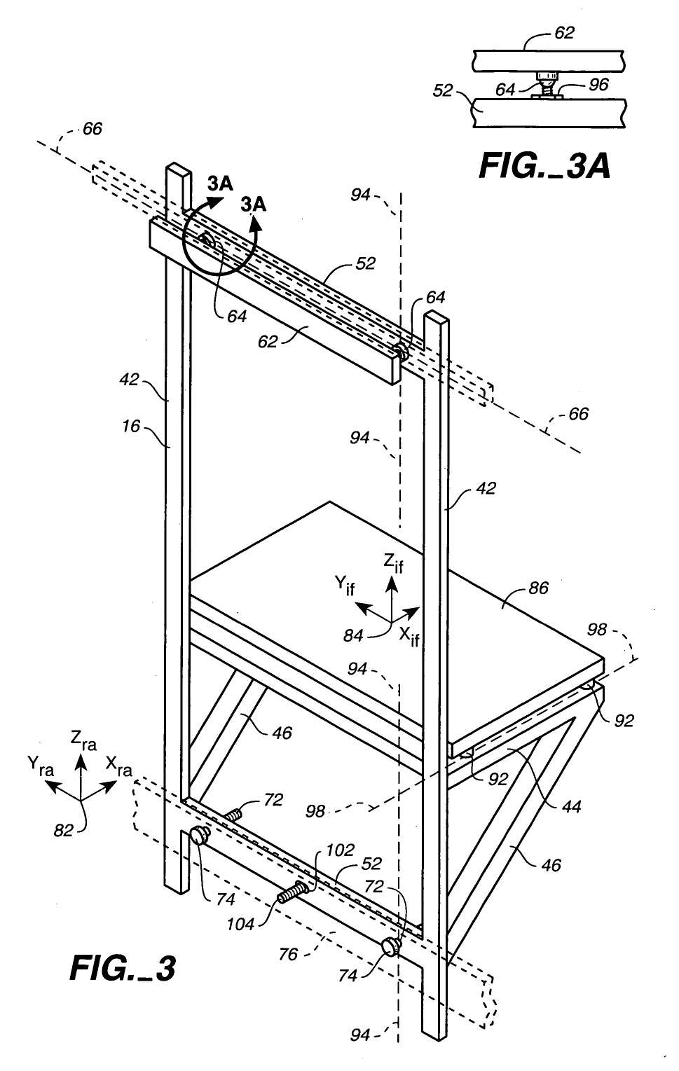

To facilitate aligning the load-port-interface frame 16 to the remainder of the front-end module 10, as depicted in FIG. 3 each load-port-interface frame 16 is adjustably secured with respect to the rail 18 and the robot arm 12 of the front-end module 10 with at least two (2) independent degrees of freedom. Accordingly, the upper brace 52 of the load-port-interface frame 16 hangs from an upper support beam 62 that is included in the front-end module 10. The upper support beam 62 is securely mounted within the front-end module 10 with respect to the rail 18. As explained in greater detail below and depicted in FIG. 3, the upper support beam 62 may be a two-piece linear slide. In the illustration of FIG. 3, an upper half of the upper support beam 62 is depicted with dashed lines because it is rigidly attached with respect to the rail 18. A lower half of the upper support beam 62 is depicted with solid lines because, as explained in greater detail below, it may be moveable with respect to the rail 18.

The upper brace 52 is secured to the upper support beam 62 by two ball and socket joints 64. Hung in this way, the load-port-interface frame 16 is free to rotate about a horizontal axis 66 which passes through each of the ball and socket joints 64. The lower brace 52 of the load-port-interface frame 16 is pierced near opposite ends by a pair of adjusting screws 72 each of which includes a head 74. The heads 74 of the adjusting screws 72 contact a lower reference beam 76 which is depicted with dashed lines in FIG. 3 because it is securely mounted within the front-end module 10 with respect to the rail 18.

FIG. 3 depicts a reference frame 82 of an end effector of the robot arm 12 which includes three mutually orthogonal axes, Xᵣₐ, Yᵣₐ and Zᵣₐ. FIG. 3 also depicts a reference frame 84 for a opener platform 86 which rests upon the load-port-interface frame 16. Similar to the reference frame 82, the reference frame 84 includes three mutually orthogonal axes, X_{if}, Y_{if} and Z_{if}. Using both of the adjusting screws 72, the load-port-interface frame 16 may be rotated about the horizontal axis 66 until the axis Z_{if} of the reference frame 84 becomes oriented parallel to the axis Zᵣₐ of the reference frame 82.

A vertical axis 94 passes through one of the ball and socket joints 64 and one of the adjusting screws 72 which preferably includes a ball and socket. As illustrated in FIG. 3, the vertical axis 94 is not parallel to the horizontal axis 66. By adjusting the ball and socket joint 64 and the adjusting screw 72 which are distal from the vertical axis 94, the load-port-interface frame 16 rotates about the vertical axis 94 until the axis X_{if} of the reference frame 84 becomes oriented parallel to the axis Xᵣₐ of the reference frame 82. Upon completing adjustment of the ball and socket joint 64 and the adjusting screw 72 which are distal from the vertical axis 94, the plane X_{if}-Z_{if} of the reference frame 84 is oriented parallel to the plane Xᵣₐ-Zᵣₐ of the reference frame 82. After these two planes have been aligned, a lock nut 96 illustrated in FIG. 3A, that is included in the ball and socket joint 64 which is distal from the vertical axis 94, is tightened against the upper brace 52. The adjusting screw 72 which is distal from the vertical axis 94 also preferably includes a lock nut 96 which is tightened against the lower brace 52.

Similarly to the coupling between the upper brace 52 and the upper support beam 62, the opener platform 86 is supported above one of the beams 44 of the load-port-interface frame 16 by a pair of ball and socket joints 92. Supported in this way, the opener platform 86 is free to rotate about a horizontal axis 98 which passes through each of the ball and socket joints 92. As illustrated in FIG. 3, the horizontal axis 98 is not parallel either to the horizontal axis 66 or to the vertical axis 94. Adjusting screws, that are not illustrated in FIG. 3 and which are similar to the adjusting screws 72, are interposed between the opener platform 86 and the other beam 44 of the load-port-interface frame 16 which is distal from the ball and socket joints 92. Using the adjusting screws that are not illustrated in FIG. 3, the opener platform 86 may be rotated about the horizontal axis 98 until the plane X_{if}-Y_{if} of the reference frame 84 becomes oriented parallel to the plane Xᵣₐ-Yᵣₐ of the reference frame 82.

As described thus far with respect to the illustration of FIG. 3, the front-end module 10 exhibits three (3) independent degrees of freedom which permit orienting the opener platform 86 so all three axes of the reference frame 84 are parallel to the three axes of the reference frame 82. An embodiment of the front-end module 10 wherein the upper support beam 62 is a two-piece linear slide further permits translating the load-port-interface frame 16 parallel to the horizontal axis 66. Translation of the load-port-interface frame 16 parallel to the horizontal axis 66 provides yet a fourth independent degree of freedom for the opener platform 86. Such an embodiment of the front-end module 10 advantageously permits also aligning the X_{if} axis of the reference frame 84 collinearly with the Xᵣₐ axis of the reference frame 82.

In addition to being pierced by the two adjusting screws 72, as depicted in FIG. 3 the lower brace 52 of the load-port-interface frame 16 is also preferably pierced by at least one horizontally oriented slot 102 which receives a bolt 104. Threads of the bolt 104 engage a threaded hole that pierces the lower reference beam 76. After the reference frame 84 of the load-port-interface frame 16 has been suitably aligned with the reference frame 82 of the robot arm 12, the bolt 104 may be tightened thereby locking the load-port-interface frame 16 in its aligned location.

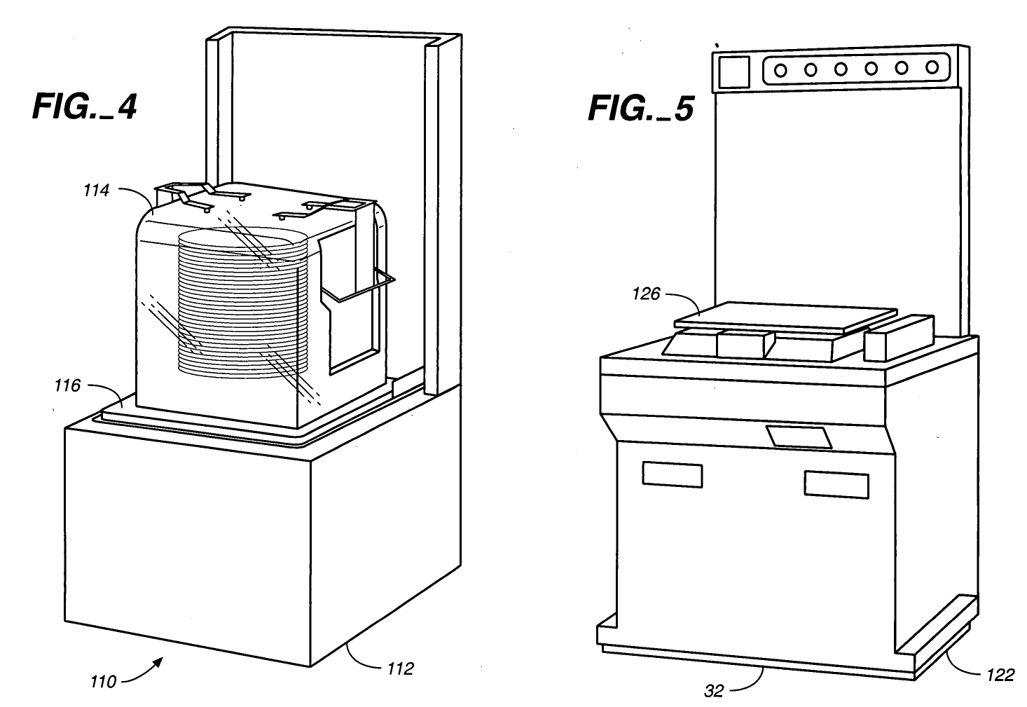

FIG. 4 illustrates a half-height SMIF pod opener that is referred to by the general reference character 110. The SMIF pod opener 110 includes a base 112 that is adapted to be received onto the opener platform 86 depicted in FIG. 3. In the illustration of FIG. 4, a SMIF pod 114 is secured to a SMIF pod opener platform 116 included in an upper portion of the SMIF pod opener 110. FIG. 5 illustrates in greater detail the FOUP opener 32 depicted in FIG. 1. As depicted in FIG. 5, the FOUP opener 32 includes a base 122 that is adapted to be received onto the opener platform 86, and a FOUP opener platform 126 that is adapted to receive the FOUP 34.

To convert the front-end module 10 from handling one size of semiconductor wafers, e.g. 300 mm diameter wafers, to a different size of semiconductor wafers, e.g. 200 mm diameter wafers, first the FOUP openers 32 are removed from respective opener platforms 86, likely using a moveable fork lift like tool for carrying each FOUP opener 32. Then using the same type of equipment, the SMIF pod openers 110 are installed onto the opener platforms 86 formerly occupied by the FOUP openers 32. Then, depending upon the specific configuration of an end effector included in the robot arm 12, it may or may not be necessary to change the end effector to adapt the robot arm 12 for handling the different size of semiconductor wafer or wafer carrier. Lastly, using the adjustments provided by the load-port-interface frame 16, each of the FOUP openers 32 are adjusted in at least two (2) degrees of freedom with respect to the front-end module 10 to permit the robot arm 12 to effect exchanges of semiconductor wafers between the FOUP openers 32 and the semiconductor processing tool.

Although the present invention has been described in terms of the presently preferred embodiment, it is to be understood that such disclosure is purely illustrative and is not to be interpreted as limiting. Consequently, without departing from the spirit and scope of the invention, various alterations, modifications, and/or alternative applications of the invention will, no doubt, be suggested to those skilled in the art after having read the preceding disclosure. Accordingly, it is intended that the following claims be interpreted as encompassing all alterations, modifications, or alternative applications as fall within the true spirit and scope of the invention.

What is claimed is:

1. A front-end module adapted for exchanging semiconductor wafers between a pod and a semiconductor processing tool to which the front-end module is secured, the front-end module comprising:
a robot arm adapted for exchanging semiconductor wafers, either individually or in a wafer carrier, between a pod and the semiconductor processing tool; and
at least a first load-port-interface frame having a platform which is adapted for receiving and supporting a pod opener, the first load-port-interface frame being adjustable with respect to the robot arm for aligning thereto a pod opener received on the platform thereof;
whereby the front-end module is adapted for accurately locating a pod opener supported on the platform of the first load-port-interface frame with respect to the robot arm.

2. The front-end module of claim 1 further comprising a pod opener received and supported on the platform of the first load-port-interface frame, wherein the pod opener is adapted for opening and closing a pod selected from a group consisting of:
a SMIF pod; or
a FOUP.

3. The front-end module of claim 1 wherein the platform of the first load-port-interface frame is adjustable with respect to the robot arm in at least two (2) degrees of freedom.

4. The front-end module of claim 3 wherein the two (2) degrees of freedom in which the platform of the first load-port-interface frame is adjustable with respect to the robot arm are rotation about two (2) nonparallel axes.

5. The front-end module of claim 4 wherein the platform of the first load-port-interface frame is also linearly translatable along an axis.

6. The front-end module of claim 5 wherein the platform of the first load-port-interface frame is linearly translatable substantially parallel to one of the two (2) nonparallel axes.

7. The front-end module of claim 1 wherein the platform of the first load-port-interface frame is adjustable with respect to the robot arm in at least three (3) degrees of freedom.

8. The front-end module of claim 7 wherein the three (3) degrees of freedom in which the platform of the first load-port-interface frame is adjustable with respect to the robot arm are rotation about three (3) nonparallel axes.

9. The front-end module of claim 8 wherein the platform of the first load-port-interface frame is also linearly translatable substantially parallel to one of the three (3) nonparallel axes.

10. The front-end module of claim 1 wherein:
the front-end module further comprises at least a second load-port-interface frame having a platform which is adapted for receiving and supporting a pod opener, the second load-port-interface frame being adjustable with respect to the robot arm for aligning thereto a pod opener received on the platform thereof,
whereby the front-end module is adapted for accurately locating a pod opener supported on the platform of the second load-port-interface frame with respect to the robot arm; and
the robot arm is moveable within the front-end module with respect to both the first and second load-port-interface frames for exchanging semiconductor wafers:
with a pod opener received and supported on the platform of the first load-port-interface frame when the robot arm is located in a first position; and
with a pod opener received and supported on the platform of the second load-port-interface frame when the robot arm is located in a second position that differs from the first position.

11. The front-end module of claim 10 further comprising pod openers received and supported on platforms respectively of the first load-port-interface frame and of the second load-port-interface frame, wherein each pod opener is adapted for opening and closing a pod selected from a group consisting of:
a SMIF pod; or
a FOUP.

12. The front-end module of claim 10 wherein the platforms of the first load-port-interface frame and of the second load-port-interface frame are respectively adjustable with respect to the robot arm in at least two (2) degrees of freedom.

13. The front-end module of claim 12 wherein the two (2) degrees of freedom in which each platform is adjustable with respect to the robot arm are rotation about two (2) nonparallel axes.

14. The front-end module of claim 13 wherein each platform is also linearly translatable along an axis.

15. The front-end module of claim 14 wherein each platform is linearly translatable substantially parallel to one of the two (2) nonparallel axes.

16. The front-end module of claim 10 wherein the platforms of the first load-port-interface frame and of the second load-port-interface frame are respectively adjustable with respect to the robot arm in at least three (3) degrees of freedom.

17. The front-end module of claim 16 wherein the three (3) degrees of freedom in which each platform is adjustable with respect to the robot arm are rotation about three (3) nonparallel axes.

18. The front-end module of claim 17 wherein each platform is also linearly translatable substantially parallel to one of the three (3) nonparallel axes.

19. A method for coupling a pod opener to a semiconductor processing tool for exchanging semiconductor wafers between a pod and the semiconductor processing tool comprising the steps of:
securing a front-end module to the semiconductor processing tool, the front-end module including:
a robot arm adapted for exchanging semiconductor wafers, either individually or in a wafer carrier, between a pod and the semiconductor processing tool; and
at least a first load-port-interface frame having a platform which is adapted for receiving and supporting a pod opener, the load-port-interface frame being adjustable with respect to the robot arm for aligning thereto a pod opener received on the platform thereof;
disposing a pod opener on the platform of the first load-port-interface frame; and
adjusting the platform of the first load-port-interface frame with respect to the robot arm to accurately locate the pod opener with respect to the robot arm.

20. The method of claim 19 further comprising the step of selecting the pod from a group consisting of:
a SMIF pod; or
a FOUP.

21. The method of claim 19 wherein the platform of the first load-port-interface frame is adjusted with respect to the robot arm in at least two (2) degrees of freedom.

22. The method of claim 21 wherein the two (2) degrees of freedom in which the platform of the first load-port-interface frame is adjusted with respect to the robot arm are rotation about two (2) nonparallel axes.

23. The method of claim 22 further comprising the step of linearly translating the platform of the first load-port-interface frame along an axis.

24. The method of claim 23 wherein the platform of the first load-port-interface frame is linearly translatable substantially parallel to one of the two (2) nonparallel axes.

25. The method of claim 19 wherein the platform of the first load-port-interface frame is adjusted with respect to the robot arm in at least three (3) degrees of freedom.

26. The method of claim 25 wherein the three (3) degrees of freedom in which the platform of the first load-port-interface frame is adjusted with respect to the robot arm are rotation about three (3) nonparallel axes.

27. The method of claim 26 further comprising the step of linearly translating the platform of the first load-port-interface frame substantially parallel to one of the three (3) nonparallel axes.

28. The method of claim 19 wherein the front-end module further comprises at least a second load-port-interface frame having a platform which is adapted for receiving and supporting a pod opener, the second load-port-interface frame being adjustable with respect to the robot arm for aligning thereto a pod opener received on the platform thereof,
further comprising the steps of:
disposing a pod opener on the platform of the second load-port-interface frame; and
adjusting the platform of the second load-port-interface frame with respect to the robot arm to accurately locate the pod opener with respect to the robot arm.

29. The method of claim 28 further comprising the step of moving the robot arm within the front-end module with respect to both the first and second load-port-interface frames for exchanging semiconductor wafers:
with a pod opener received and supported on the platform of the first load-port-interface frame when the robot arm is located in a first position; and
with a pod opener received and supported on the platform of the second load-port-interface frame when the robot arm is located in a second position that differs from the first position.
